(19) United States
(12) Patent Application Publication
(10) Pub. No.: US 2017/0305366 A1
(43) Pub. Date: Oct. 26, 2017

(54) GROMMET AND ELECTRIC WIRE WITH GROMMET

(71) Applicant: Sumitomo Wiring Systems, Ltd., Yokkaichi, Mie (JP)

(72) Inventor: Satoshi UJITA, Yokkaichi, Mie (JP)

(21) Appl. No.: 15/523,577

(22) PCT Filed: Nov. 27, 2015
(86) PCT No.: PCT/JP2015/083333

§ 371 Date: May 1, 2017

(30) Foreign Application Priority Data
Dec. 16, 2014 (JP) 2014-253922

(51) Int. Cl. B60R 16/02; H01B 17/58; H01B 7/28; H02G 3/22; F16L 5/02

(52) U.S. Cl. CPC B60R 16/02; H02G 3/22; F16L 5/02; H01B 7/28; H01B 17/58

(57) ABSTRACT

A grommet includes a cylindrical portion and an attachment portion formed to project from an outer peripheral portion of the cylindrical portion. An annular groove into which an inner peripheral edge portion of the through-hole can be fitted is formed in an outer peripheral portion of the attachment portion. A bottom face of the annular groove is formed with a racetrack shape having a pair of straight portions and a pair of arc portions that are formed with an outwardly convex arc shape and respectively connect end portions of the pair of straight portions on one side and end portions on the other side. Inner peripheral portions of the arc portions include portions in which the thickness dimension gradually increases from the centers of the arc portions toward connection portions that connect the arc portions to the straight portions.

### CROSS REFERENCE TO RELATED APPLICATIONS

This application claims the priority of Japanese patent application JP2014-253922 filed on Dec. 16, 2014, the entire contents of which are incorporated herein.

### TECHNICAL FIELD

This invention relates to a grommet for attachment to a through-hole formed in a vehicle panel or the like.

### BACKGROUND ART

There are cases where a through-hole is formed in a vehicle panel or the like in order to allow an electric wire to be drawn from one side of the panel to the other side, and a grommet is attached to the through-hole in order to protect the electric wire from the inner peripheral edge of the through-hole and to suppress the case where water or the like intrudes through the through-hole.

In the case where the through-hole is formed with a racetrack shape, and a groove corresponding to the racetrack shape is formed in the outer periphery of the grommet as well, there is a problem in that a gap is easily formed between the grommet and the through-hole when the grommet is attached to the through-hole. This is because the straight portions of the groove formed in the grommet easily bend inward, resulting in the formation of a gap between the straight portions of the groove and the straight portions of the peripheral edge portion of the through-hole.

In view of this, in Patent Document 1 (JP H5-47675U), the groove portion is formed with an elliptical outer peripheral shape to make it more difficult for the groove portion to deform inward. Also, ribs are provided in the four corners of the elliptical shape of the groove portion to reinforce the groove portion, and the ribs are brought into close contact with the through-hole.

### SUMMARY

However, according to the technique disclosed in Patent Document 1, portions can appear in which there is poor consistency between the shape of the inner peripheral edge portion of the through-hole and the outer peripheral shape of the groove portion, and there is a poor state of contact between the inner peripheral edge portion of the through-hole and the bottom face of the groove portion. For example, there is concern of poor contact between the inner peripheral edge portion of the through-hole and the bottom face of the groove portion in the connection portions where the arc portions of the groove portion on the two sides in the short axis direction of the ellipse are connected to the arc portions on the two sides in the long axis direction of the ellipse.

Also, although ribs are provided in Patent Document 1, it is difficult to ensure stable water cut-off ability in the groove portion over the entirety of the extending direction thereof due to the fact that, for example, the protruding dimensions of the ribs differ between portions along the extending direction of the groove portion, portions where the ribs are in contact with the through-hole and portions where the bottom of the groove portion is in direct contact with the through-hole both exist, and the ribs deform in accordance with deformation of the grommet itself

In view of this, an object of the present invention is to, in a grommet for attachment to a racetrack-shaped through-hole, improve water cut-off ability between the inner peripheral edge portion of the through-hole and the bottom face of an annular groove in the grommet.

In order to solve the above-described problems, a first aspect is a grommet for attachment to a racetrack-shaped through-hole formed in a panel of a vehicle, the grommet including: a cylindrical portion into which an electric wire is inserted; and an attachment portion formed to project from an outer peripheral portion of the cylindrical portion, an annular groove into which an inner peripheral edge portion of the through-hole can be fitted being formed in an outer peripheral portion of the attachment portion, wherein a bottom face of the annular groove is formed with a racetrack shape having a pair of straight portions and a pair of arc portions that are formed with an outwardly convex arc shape and respectively connect end portions of the pair of straight portions on one side and end portions on another side, and inner peripheral portions of the pair of arc portions include portions in which a thickness dimension gradually increase from centers of the pair of arc portions toward connection portions that connect the pair of arc portions to the pair of straight portions.

A second aspect is the grommet according to the first aspect, wherein inner peripheral surfaces of inner peripheral portions of the pair of straight portions are formed with a shape that draws an outwardly convex arc.

A third aspect is the grommet according to the second aspect, wherein a thickness dimension of inner peripheral portions in centers of the pair of straight portions is larger than a thickness dimension of inner peripheral portions in centers of the pair of arc portions.

A fourth aspect is the grommet according to the first aspect, wherein inner peripheral portions of the pair of straight portions are formed with a uniform thickness dimension along an extending direction of the inner peripheral portions.

A fifth aspect includes the grommet according to any one of the first to fourth aspects, and at least one electric wire that passes through the cylindrical portion.

According to the first to fifth aspects, the connection portions where the inner peripheral portions of the arc portions are connected to the inner peripheral portions of the straight portions have a relatively large thickness dimension, and thus do not bend easily. Accordingly, the straight portions do not easily deform inward, and a gap is not easily formed between the straight portions of the bottom face of the annular groove and the inner peripheral edge portions of the through-hole. Also, the inner peripheral portions in the centers of the arc portions have a relatively small thickness dimension, and therefore when the peripheral edge portion of the through-hole has been fitted into annular groove, force for causing contraction of the inner peripheral portion of the annular groove is mainly absorbed in the centers of the arc portions. Each arc portion itself does not easily bend inward much due to its shape, and therefore it is possible to maintain a favorable state of contact between the arc portions and the peripheral edge portion of the through-hole. As a result, it is possible to minimize the formation of a gap between the inner peripheral edge portion of the through-hole and the bottom face of the annular groove over the entirety of the peripheral direction of the bottom face of the annular groove, and it is possible to improve water cut-off ability between the inner peripheral edge portion of the through-hole and the bottom face of the annular groove.

According to the second aspect, the inner peripheral surfaces of the inner peripheral portions of the straight portions exhibit an arch structure, and therefore it is possible to suppress deformation of the inner peripheral portions of the straight portions while also reducing the weight of the grommet.

According to the third aspect, it is possible to more reliably suppress deformation of the inner peripheral portions of the straight portions.

According to the fourth aspect, the inner peripheral portions of the straight portions have approximately the same thickness dimension as the inner peripheral portions of the connection portions that connect the arc portions to the straight portions, and this thickness dimension is uniform over the extending direction of the inner peripheral portions of the straight portions, and therefore it is possible to more reliably suppress deformation of the inner peripheral portions of the straight portions.

### BRIEF DESCRIPTION OF DRAWINGS

FIG. 1 is a perspective view of a grommet according to an embodiment.

FIG. 2 is a schematic side view of a state in which an electric wire with a grommet is attached to a panel.

FIG. 3 is an illustrative diagram showing a state in which the cross-sectional shape of an attachment portion is projected on the peripheral edge portion of a through-hole in the panel.

FIG. 4 is a cross-sectional view of an attachment portion according to another example.

FIG. 5 is an illustrative diagram showing a state in which the cross-sectional shape of an attachment portion according to a variation is projected on the peripheral edge portion of a through-hole in a panel.

### DESCRIPTION OF EMBODIMENTS

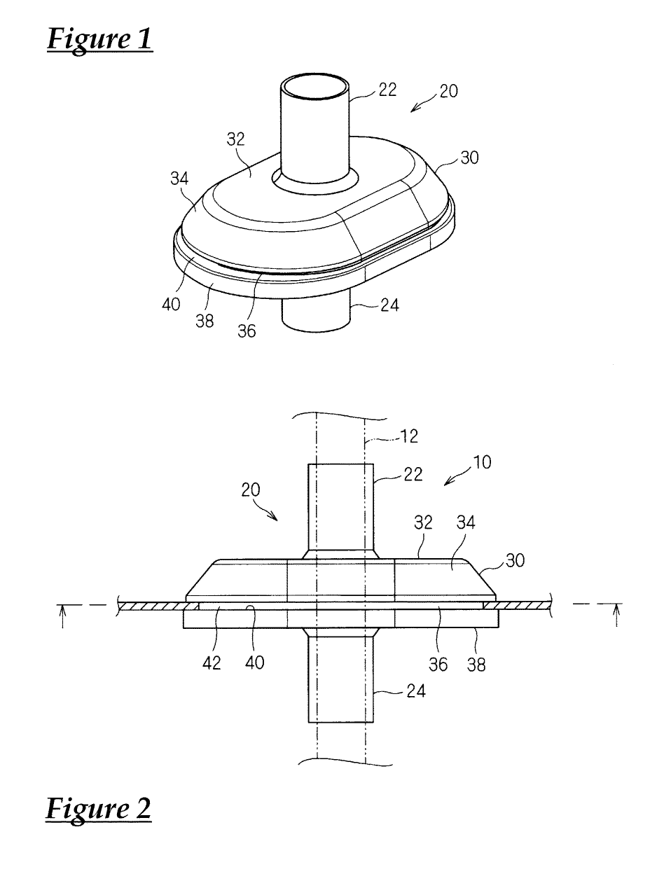

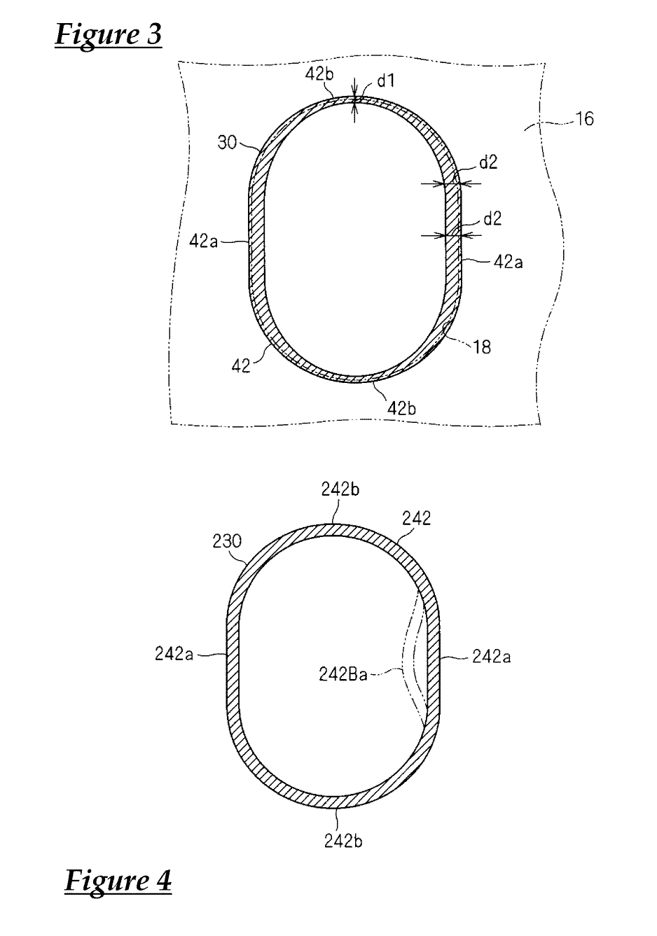

Hereinafter, a grommet and an electric wire with the grommet according to an embodiment will be described. FIG. 1 is a perspective view of a grommet 20, and FIG. 2 is a schematic side view of a state in which an electric wire with grommet 10 has been attached to a panel 16 (i.e., the grommet attachment structure of the electric wire with grommet 10). Also, FIG. 3 shows a state in which the cross-sectional shape of an attachment portion 30 is projected onto the peripheral edge portion of a through-hole 18 of the panel 16, this cross-section being taken along a plane that is orthogonal to the center axis of the attachment portion 30 (which matches the center axis of cylindrical portions 22 and 24) and also passes through an annular groove 40. Note that in this projection state, the center of the cross-sectional shape and the center of the through-hole 18 match each other.

The electric wire with grommet 10 includes electric wires 12 and the grommet 20.

Here, the electric wire with grommet 10 includes multiple electric wires 12. The electric wires 12 are bundled together to form a circular cross-section in the portion to which the grommet 20 is to be attached. The electric wires 12 may be branched outside of the grommet. Terminals are attached to end portions of the electric wires 12, and the terminals are inserted into and held in connectors. Also, when the electric wire with grommet 10 is installed in a vehicle, the connectors are connected to various electrical parts installed in the vehicle, and therefore the electrical parts are connected to each other via the electric wires 12. In other words, the electric wire with grommet 10 is used as an electrical wiring member in a vehicle. Optical fiber cables may be bundled together in an electric wire 12. FIG. 2 shows the outer shape of the bundle of electric wires 12.

The grommet 20 is a member that is inserted through and attached to the through-hole 18 formed in the panel 16 of the vehicle.

The panel 16 is envisioned to be a metal plate that separates portions in the vehicle, such as a metal plate that separates the engine room and the vehicle interior, or a metal plate that separates the vehicle interior from the outside.

The through-hole 18 for passage of the electric wires 12 is formed in the panel 16. The through-hole 18 is formed with a racetrack shape. This racetrack shape refers to a shape defined by a pair of straight lines that are parallel to each other and are arranged at a positions where the end portions are aligned in the extending direction, and a pair of arcs that are outwardly convex and respectively connect together end portions of the pair of straight lines on one side and connect together end portions of the pair of straight lines on the other side. The term arc includes a circular arc, but is not required to be a circular arc.

The grommet 20 with the electric wires 12 therein is inserted into and attached to the through-hole 18. Accordingly, the grommet 20 plays the role of protecting the electric wires 12 from the peripheral edge portion of the through-hole 18, and also suppressing the intrusion of water or the like from the space on one side of the panel 16 into the space on the other side.

The grommet 20 is a member that is molded as a single piece by a mold using an elastomer such as rubber, and includes cylindrical portions 22 and 24 and the attachment portion 30.

The cylindrical portion 22 is formed with the shape of a cylinder through which the electric wires 12 can pass. The inner diameter of the cylindrical portion 22 is set approximately the same as or smaller (slightly smaller) than the outer diameter of the bundle of electric wires 12. The cylindrical portion 22 is elastically deformed so as to increase in diameter, and the bundle of electric wires 12 is inserted into the cylindrical portion 22 in this state and held therein. Preferably, adhesive tape or the like is wrapped around the end portion of the cylindrical portion and the bundled portion of the electric wires 12 that extends from the end portion in this state.

Similarly to the cylindrical portion 22, the cylindrical portion 24 is formed with the shape of a cylinder through which the electric wires 12 can pass. The cylindrical portions 22 and 24 extend from respective sides of the attachment portion 30, and are arranged on the same axis. The bundle of electric wires 12 is inserted from the cylindrical portion 22 into cylindrical portion 24 through the attachment portion 30. Either the cylindrical portion 22 or the cylindrical portion 24 may be omitted.

The attachment portion 30 is formed with a shape of projecting from the outer peripheral portion of the cylindrical portions 22 and 24, and an annular groove 40, into which the inner peripheral edge portion of the through-hole 18 can be fitted, is formed in the outer peripheral portion. Also, a space in communication with the cylindrical portions 22 and 24 is formed inside the attachment portion 30.

More specifically, the attachment portion 30 includes a flange portion 32 that expands outward from an end portion of the cylindrical portion 22, a skirt-shaped portion 34 that gradually spreads out from the outer peripheral portion of the flange portion 32 toward the cylindrical portion 24, a flange portion 38 that expands outward from an end portion of the cylindrical portion 24, and a connection portion 36 that connects the skirt-shaped portion 34 and the flange portion 38.

The flange portion 32 is formed with a racetrack shape, and the edge portion of the outermost portion of the skirt-shaped portion 34 also exhibits a racetrack shape. The flange portion 38 also exhibits a racetrack shape of the same size as or larger than the edge portion of the outermost portion of the skirt-shaped portion 34.

Also, the connection portion 36 exhibits a racetrack shape that is smaller than the edge portion of the outermost portion of the skirt-shaped portion 34 and the outer peripheral edge portion of the flange portion 38.

The outermost portion of the skirt-shaped portion 34 and the flange portion 38 are connected via the connection portion 36, and an annular groove 40 is formed between the skirt-shaped portion 34 and the flange portion 38. The outer circumferential surface of the connection portion 36 serves as a bottom face 42 of the annular groove 40, and opposing surfaces of the outermost portion of the skirt-shaped portion 34 and the flange portion 38 serve as annular side faces of the annular groove 40.

The bottom face 42 of the annular groove 40 is formed with a racetrack shape. Specifically, the bottom face 42 includes a pair of straight portions 42a and a pair of arc portions 42b. The pair of straight portions 42a are parallel with each other, and are formed at positions where the end portions thereof are aligned in the extending direction. Also, one of the arc portions 42b is formed with an outwardly convex arc shape and connects together end portions of the pair of straight portions 42a on one side. Also, the other arc portion 42b is formed with an outwardly convex arc shape and connects together end portions of the pair of straight portions 42a on the other side.

The thickness dimension of the portion of the attachment portion 30 on the inner circumferential side of the annular groove 40 (i.e., the connection portion 36) is set to gradually increase from the central portion of the pair of arc portions 42b toward the pair of arc portions 42b and the pair of straight portions 42a.

Also, in this case, the thickness dimension of the inner peripheral portions of the pair of straight portions 42a is set uniform along the extending direction.

In this case, the shape of the inner peripheral surface of the portion of the attachment portion 30 on the inner circumferential side of the annular groove 40 (i.e., the shape of the inner peripheral surface of the connection portion 36) exhibits a racetrack shape that is smaller than the racetrack shape of the bottom face 42.

Also, the thickness dimension of the inner peripheral portions in the central portions of the pair of arc portions 42b is set to d1, the thickness dimension of the inner peripheral portions of the end portions of the pair of arc portions 42b, which are the connection portions that connect the pair of arc portions 42b to the pair of straight portions 42a, is set to d2 (d1<d2), and the thickness dimension of the inner peripheral portions of the pair of arc portions 42b is set to gradually increase from d1 to d2. Also, the thickness dimension of the inner peripheral portions of the pair of straight portions 42a is maintained at the thickness dimension d2 of the connection portions over the entirety of the extending direction.

Note that the size of the racetrack shape of the bottom face 42 is smaller than the size of the racetrack shape of the through-hole 18. Preferably, the size of the racetrack shape of the bottom face 42 is smaller than the size of the racetrack shape of the through-hole 18 to the extent that each portion of the bottom face 42 is located inward of the through-hole 18 by a constant dimension over the entirety of the peripheral direction of the racetrack shape of the through-hole 18.

According to the grommet 20 and the electric wire with grommet 10 having the above configuration, it is possible to minimize the formation of a gap between the inner peripheral edge portion of the through-hole 18 and the bottom face of the annular groove 40, and it is possible to improve water cut-off ability between the inner peripheral edge portion of the through-hole 18 and the bottom face of the annular groove 40.

This will be described in more detail below.

First, FIG. 4 is a cross-sectional view showing the case where in an attachment portion 230 that corresponds to the above-described attachment portion 30, the thickness dimension of the inner peripheral portion of the bottom face 242 of the annular groove is uniform over the entirety of the peripheral direction of the inner peripheral portion. In this case, when the inner peripheral edge portion of the through-hole is fitted into the annular groove, the entirety of the bottom face 242 of the annular groove is pressed inward. Upon conducting a detailed examination of the state of deformation of the bottom face 242 in this case, the inventors of the present invention made the following findings.

First, due to the fact that the inner peripheral portions of arc portions 242b exhibit an outwardly convex arc shape, they do not easily bend circumferentially inward, and a state of favorable contact with the inner peripheral edge portion of the through-hole 18 is maintained. On the other hand, due to the fact that the inner peripheral portions of the straight portions 242a exhibit a straight shape, there are cases where they deform inward as shown by straight portion 242Ba indicated by dashed double-dotted lines in the figure. A detailed examination of this deformed state revealed that the straight portion 242a not only deformed in an intermediate portion in the extending direction, but also deforms circumferentially inward starting at the connection portion between the straight portion 242a and the arc portion 242b.

In view of this, in the present embodiment, the thickness dimension of the portion of the attachment portion 30 on the inner circumferential side of the annular groove 40 is set to gradually increase from the central portions of the pair of arc portions 42b toward the connection portions that connect the pair of arc portions 42b to the pair of straight portions 42a. Accordingly, bending does not easily occur between the inner peripheral portions of the arc portions 42b and the inner peripheral portions of the straight portions 42a, and therefore the inner peripheral portions of the straight portions 42a also do not easily deform inward. Accordingly, a gap is not easily formed between the straight portions 42a of the bottom face 42 of the annular groove 40 and the inner peripheral edge portion of the through-hole 18.

Also, the inner peripheral portions in the centers of the arc portions 42b have a relatively small thickness dimension, and therefore when the peripheral edge portion of the through-hole 18 has been fitted into the annular groove 40, force for causing contraction of the inner peripheral portion of the annular groove is mainly absorbed in the centers of the arc portions 42b. In this case, each arc portion 42b itself exhibits an outwardly convex arc shape, and therefore does not easily bend inward, and it is possible to maintain a favorable state of contact between the arc portions 42b and the inner peripheral edge portion of the through-hole 18.

As a result, it is possible to minimize the formation of a gap between the inner peripheral edge portion of the through-hole 18 and the bottom face 42 over the entirety of the peripheral direction of the bottom face 42 of the annular groove 40, and it is possible to improve water cut-off ability between the inner peripheral edge portion of the through-hole 18 and the bottom face 42.

Moreover, the bottom face 42 is formed with a racetrack shape similarly to the through-hole 18, and therefore inconsistency does not easily arise between the shapes thereof as in the case where the outer peripheral shape of the groove portion is elliptical as in conventional technology, and in view of this as well, it is possible to improve water cut-off ability between the bottom face 42 and the through-hole 18.

Also, the inner peripheral portions of the straight portions 42a have approximately the same thickness dimension d2 as the inner peripheral portions of the connection portions that connect the arc portions 42b to the straight portions 42a, and this thickness dimension d2 is uniform over the extending direction, and therefore it is possible to more reliably suppress deformation of the inner peripheral portions of the straight portions 42a.

Note that although the thickness dimension d2 of the inner peripheral portions of the straight portions 42a is set the same along the extending direction thereof in the above embodiment, the present invention is not necessarily required to have this configuration.

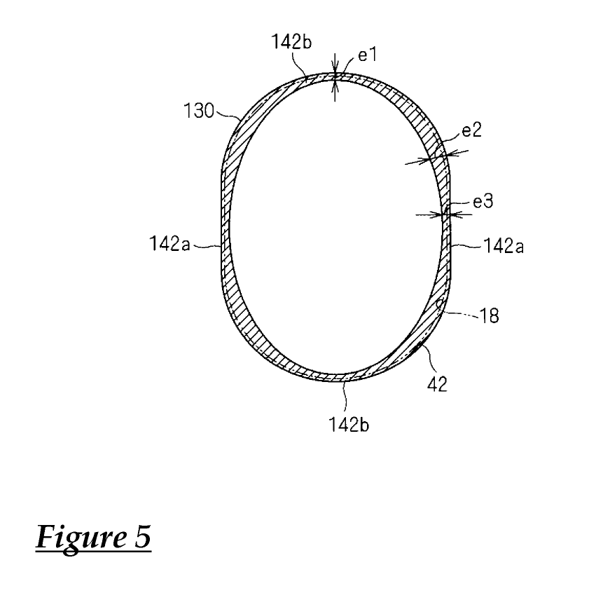

For example, in a variation shown in FIG. 5, in an attachment portion 130 that corresponds to the attachment portion 30, the bottom face 42 of the annular groove is formed with the same shape as in the above embodiment, but the inner peripheral surface of the portion of the attachment portion 130 on the inner circumferential side of the bottom face 42 is formed with an elliptical shape (a mathematically defined elliptical shape).

In this variation, a pair of arc portions 142b, which correspond to the pair of arc portions 42b, include portions in which the thickness dimension gradually increases from the centers of the arc portions 142b toward the connection portions that connect the arc portions 142b to straight portions 142a that correspond to the straight portions. Specifically, the thickness dimension of the inner peripheral portions in the central portions of the arc portions 142b is set to el, the thickness dimension of the portions toward the arc portions 142 in the connection portions that connect the arc portions 142b to the straight portions 142a is set to e2 (e1<e2), and the thickness dimension of the inner peripheral portions of the arc portions 142b is set to gradually increase from e1 to e2.

Also, the inner peripheral surfaces of the inner peripheral portions of the straight portions 142a draw an outwardly convex arc shape. For this reason, the thickness dimension of the inner peripheral portions in the intermediate portions of the straight portions 142a in the extending direction is e3 (e3<e2). In other words, the thickness dimension of the inner peripheral portions of the end portions of the straight portions 142a is set to gradually decrease from the end portions toward the centers.

Also, in order to more reliably suppress deformation of the straight portions 142a, it is preferable that the thickness dimension e3 of the inner peripheral portions in the centers of the straight portions 142a is greater than the thickness dimension e1 in the centers of the arc portions 142b.

According to this variation as well, the inner peripheral portions of the connection portions that connect the straight portions 142a to the arc portions 142b have a relatively large thickness dimension, and the inner peripheral portions in the centers of the arc portions 142b have a relatively large thickness dimension, and therefore similarly to the above embodiment, it is possible to minimize the formation of a gap between the inner peripheral edge portion of the through-hole 18 and the bottom face of the annular groove 40, and it is possible to improve water cut-off ability between the inner peripheral edge portion of the through-hole 18 and the bottom face of the annular groove 40. Note that it is sufficient that the inner peripheral portions of the arc portions 142b include a portion in which the thickness dimension gradually increases from the center toward the end portion (connection portion) as shown in this example, and it is not necessary that the connection portions that connect the straight portions 142a to the arc portions 142b have the largest thickness. In other words, a configuration is possible in which the thickness dimension is the largest at positions in the vicinity of the connection portions to the extent that it is possible to suppress inward deformation of the straight portions 142a.

Also, the inner peripheral surfaces of the inner peripheral portions of the straight portions 142a are formed with a shape that draws an outwardly convex arc, and therefore the portions that extend along the inner peripheral surfaces of the inner peripheral portions of the straight portions 142a form one type of arch structure. For this reason, it is possible to suppress deformation of the inner peripheral portions of the straight portions 142a while also reducing the weight of the grommet 20, and to favorably maintain an improvement in water cut-off ability between the inner peripheral edge portion of the through-hole 18 and the bottom face of the annular groove 40.

Although this invention has been described in detail above, the above description is illustrative in all respects, and this invention is not limited to the above description. It will be understood that numerous variations not illustrated here can be envisioned without departing from the range of this invention.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### REFERENCE SIGNS LIST

10 Electric wire with grommet
12 Electric wire
16 Panel
18 Through-hole
20 Grommet
22, 24 Cylindrical portion
30, 130 Attachment portion
40 Annular groove
42 Bottom face
42a, 142a Straight portion
42b, 142b Arc portion

1. A grommet for attachment to a racetrack-shaped through-hole formed in a panel of a vehicle, the grommet comprising:
a cylindrical portion into which an electric wire is inserted; and
an attachment portion formed to project from an outer peripheral portion of the cylindrical portion, an annular groove into which an inner peripheral edge portion of the through-hole can be fitted being formed in an outer peripheral portion of the attachment portion,
wherein a bottom face of the annular groove is formed with a racetrack shape having a pair of straight portions and a pair of arc portions that are formed with an outwardly convex arc shape and respectively connect end portions of the pair of straight portions on one side and end portions on another side,
inner peripheral portions of the pair of arc portions include portions in which a thickness dimension gradually increase from centers of the pair of arc portions toward connection portions that connect the pair of arc portions to the pair of straight portions, and
inner peripheral surfaces of inner peripheral portions of the pair of straight portions are formed with a shape that draws an outwardly convex arc.

2. (canceled)

3. The grommet according to claim 1, wherein a thickness dimension of inner peripheral portions in centers of the pair of straight portions is larger than a thickness dimension of inner peripheral portions in centers of the pair of arc portions.

4. The grommet according to claim 1, wherein inner peripheral portions of the pair of straight portions are formed with a uniform thickness dimension along an extending direction of the inner peripheral portions.

5. An electric wire with grommet comprising:
the grommet according to claim 1; and
at least one electric wire that passes through the cylindrical portion.
